(19) United States
(12) Patent Application Publication
(10) Pub. No.: US 2022/0366127 A1
(43) Pub. Date: Nov. 17, 2022

(54) Legal Document Generation

(71) Applicants: Chetan Desh, Bellevue, WA (US); Pradnya Desh, Bellevue, WA (US); Haresh Ved, Bellevue, WA (US)

(72) Inventors: Chetan Desh, Bellevue, WA (US); Pradnya Desh, Bellevue, WA (US); Haresh Ved, Bellevue, WA (US)

(21) Appl. No.: 17/209,992

(22) Filed: Mar. 23, 2021

Related U.S. Application Data
(60) Provisional application No. 62/993,402, filed on Mar. 23, 2020.

(51) Int. Cl. G06F 40/166; G06Q 50/18

(52) U.S. Cl. CPC G06F 40/166; G06Q 50/18

(57) ABSTRACT

Disclosed, among other things, are methods for legal file generation, which may extract domains, entities, or intents from a plurality of sources for practical applications of legal drafting or other tasks. Legal file generation may integrate human-in-the-loop (HITL) feedback, novel deep learning networks, NLG, and conversational AI, for example, to provide improved accuracy and efficiency in the provision of legal services.

### FIELD

This disclosure relates generally to legal file generation.

### BACKGROUND

In many sectors, productivity is hindered by inefficient and outdated methods. In the legal profession, for example, attorneys spend myriad hours synthesizing information from client communications, oral and written evidence, expert treatises, legal forms, and laws to produce quality work product. Although artificial intelligence (AI) applications are designed to save time, they have not been adequately evaluated for accuracy and effectiveness in the legal field, among other sectors.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

Legal counsel relies heavily on human ingenuity, reasoning, and feedback. For these and other reasons, conventional AI methods on the market have been unable to overcome challenges of accuracy and effectiveness in the legal field. Disclosed are methods for legal file generation, which may extract and classify domains, entities, or intents from attorney-client communications, or other sources, for legal drafting or information collection. Legal file generation may integrate human-in-the-loop (HITL) feedback with natural language generation (NLG), deep learning networks, and conversational AI, for example, to provide significant improvements in legal services provision, auditing, compliance, training, and other practical applications.

Legal file generation may also help lawyers with disabilities, for example, if lawyer is blind or has difficulty or cannot type.

### BRIEF DESCRIPTION OF THE DRAWINGS

The present description may be better understood from the following detailed description read in light of the appended drawings, wherein:

FIG. 1 is a diagram illustrating a legal file generation process, according to one implementation.

FIG. 2 is a block diagram with components that may be used in a legal file generation system, according to one implementation.

FIG. 3 is a block diagram with components that may be used in a legal file generation system, according to another implementation.

FIG. 4 illustrates a subgraph generated by a Knowledge Engine of the legal file generation platform.

FIG. 5 is an example of an interface between a knowledge engine and subgraph components, which may be supported by a legal file generation method, according to one implementation.

FIG. 6 is a block diagram illustrating an example of a system capable of supporting a legal file generation method, according to one implementation.

FIG. 7 is a component diagram of a computing device that may support a legal file generation method, according to one implementation.

### DETAILED DESCRIPTION

A more particular description of certain implementations of Legal File Generation may be had by references to the implementations shown in the drawings that form a part of this specification, in which like numerals represent like objects.

The illustrated operations in the description show certain events occurring in a certain order. One skilled in the art will recognize that certain operations may be performed in a different order, modified, or removed. Moreover, steps may be added to the described logic and still conform to the described implementations.

Some examples of potential input to a Legal File Generation system to produce a legal document are:

A) I need to license cloud services from Microsoft. We will use the UW CoMotion agreement. Haresh Ved, COO Advocat Technologies, will work with Tom Jones, Executive Vice President, at their headquarters in Redmond, Wash. The contract will start on May 1, 2021 and will last for 5 years.

B) I will work directly with Tom Jones, Executive Vice President. Haresh Ved, Chief Operating Officer at Advocat, will represent the company. The contract starts on Mar. 1, 2021 and will last for 10 years. We will meet at the Taj Mahal in India.

C) I need a contract for the purchase of an aircraft. It's a Boeing Dreamliner, and we are buying it from Boeing, headquartered in Chicago. Can you check? Oh, and we're using Bill Jones as the broker again.

D) I need a contract for T Mobile to rent a store at the Marie Tower Site West in St. Paul, Minn. We will work with Linda Brown at Commercial Leases 'r Us. The rent will be $50,000 per year. The contract will start on May 1, 2021, and end on Apr. 30, 2031. Linda Brown's phone number is 8004432323.

E) I need an agreement for cloud software. The deal is worth more than $5M, and the data will be housed on their servers, and we need the privacy and security to be really good.

F) I need an agreement for cloud software from Microsoft for my company, BigSalesStore. The deal is worth more than $5M, and the data will be housed on their servers, and we need the privacy and security to be really good. Bob Smith will be our chief contact for this deal.

G) I need a contract for the purchase of an aircraft. It's a Boeing Dreamliner, and we are buying it from Enterprise Tech. I think they are registered in Chicago. Can you check? Oh, and we're using Alex as the broker again.

H) I need a contract for the purchase of an aircraft. It's a Gulfstream 150, and we are buying it from Enterprise Tech. I think they are registered in the Cayman Islands. Can you check? Oh, and we're using Alex as the broker again.

I) I need to purchase 1000 forklifts from Caterpillar for my company, Moveit Corp. The invoice to be submitted to our headquarters in Redmond, Wash. Our contact person their SVP, Bill Smith.

J) I need to draw up a contract for a new hire Executive Director at Good Cola. His name is Sven Haymaker, and he will report to the Board of Directors. His starting date is Aug. 1, 2021, and salary will be $250,000 per year.

K) The system may ask for information it needs during document creation. For example, a User may say “I need to create a lease agreement for the new cell site in Ontario.” The system may respond with “okay,” and a document may appear and ask “who is the owner of record?” The User may respond: “The owner of record is the City of Ontario.” The legal file generation platform may research “City of Ontario” and fill in the name and legal address for City of Ontario.

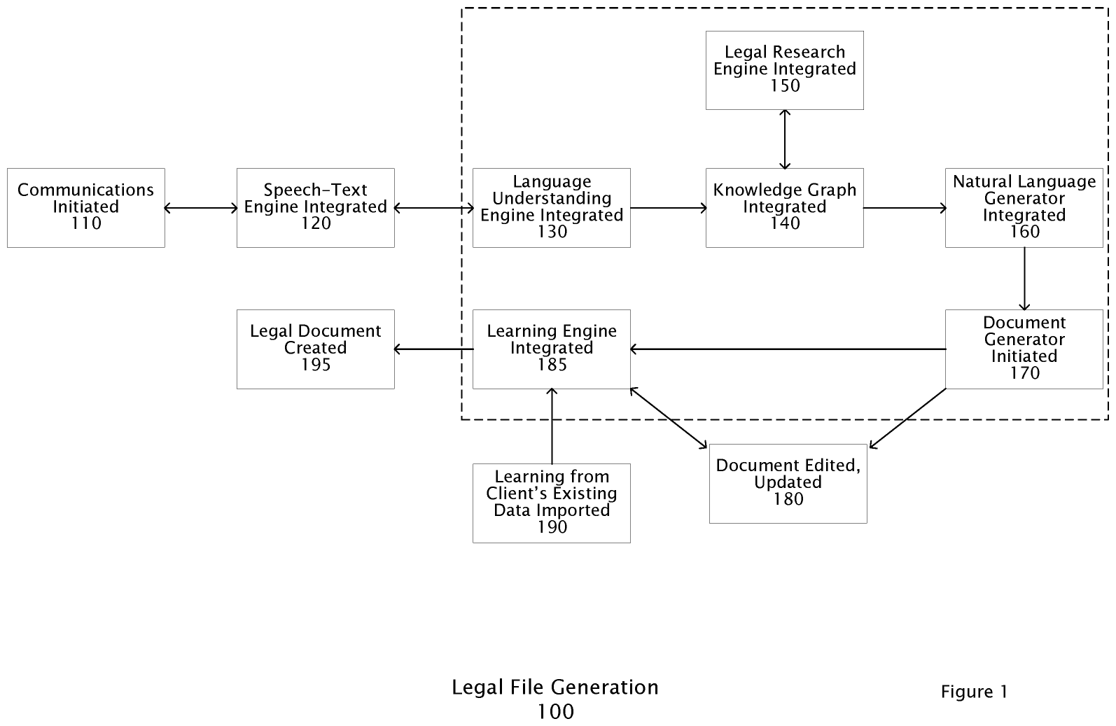

FIG. 1 is a diagram illustrating a Legal File Generation 100 process, according to one implementation. In this example, a user may comprise an attorney, an in-house counsel, a business user, a law professor, a student, or a client. A user may utilize a front-end application programming interface (API) on a device to access the Legal File Generation 100 platform. At Communications Initiated 110, one or more users may submit a request for legal services or engage in an attorney-client communication, for example.

At Speech-Text Engine Integrated 120, Legal File Generation 100 may integrate a speech-to-text conversion API to convert in real-time one or more audio inputs from the communications into text. In one implementation, Legal File Generation 100 may convert attorney-client communications from audio to text in real-time with an approximately >95% F1 accuracy score for one or more domains, entities, or intents identified from the communications. Legal File Generation 100 may integrate HITL feedback from an attorney so that any incorrect transcription that affects downstream processing may be corrected.

At Language Understanding Engine Integrated 130, the speech-to-text conversion API may receive the audio inputs and compare them with data stored in a language-understanding database. The speech-to-text conversion API may identify speakers, contents, duration, time of the communication, or other attributes and send that information to the Legal File Generation 100 platform. Voice data may be captured from any location in a meeting room or from multiple audio channels such as a phone call, a video conferencing call, or a call via a computer software application, Amazon Alexa, Echo, Google Home, or Facebook Portal, or Microsoft's Intelligent Speakers, for example. Any API integrated with Legal File Generation 100 may have security and compliance certifications that provide data safeguards and an ability to delete data to ensure compliance.

In one implementation, Legal File Generation 100 may tokenize the audio inputs and extract one or more domains, entities, contexts, relationships between entities, areas of law, or intents from the token stream. Legal File Generation 100 may apply novel deep learning networks or attention networks directly on speech for real-time extraction of domains, entities, or intents from communications or other sources. The attention networks may optimize detection keywords in a real-time voice conversation between an attorney and a client, for example. Legal File Generation 100 may integrate special networks, which include affine, convolution, attention, or other layers on the top of transfer learning from a general language domain.

Legal File Generation 100 may integrate deep Siamese, or twin neural, networks on top of natural language embeddings obtained from state-of-the-art algorithms, such as BERT, or universal sentence encoders for more accurate matching of key domains, entities, or intents in the communications with domains, intents, and entities in legal templates or documents, for example.

Domains that are overly broad may yield high error rates in detection of intents and entities, while domains that are overly granular may lead to a decrease in generalizability. As a solution, Legal File Generation 100 may classify a domain based on context to limit natural language understanding to intents and entities in a given domain.

In one implementation, Legal File Generation 100 may integrate real-time HITL feedback with attorneys, which may be supported by offline HITL from consultants. To facilitate this, deep learning-based feedback networks may learn to discern a level of impact of a user's annotation of a given discourse on inference and training, for example.

Legal File Generation 100 may enable an attorney to correct a classified domain when a false positive exists, or select a domain when a false negative occurs, while still actively speaking with a client. In one implementation, Legal File Generation 100 may comprise natural language generation (NLG) networks that learn from work product that an attorney ultimately delivers to a client. For example, Legal File Generation 100 may use Generative Pre-trained Transformer 3 (GPT-3). The NLG networks may also incorporate client feedback.

Legal File Generation 100 may classify domains, entities, or intents to switch based on a current domain. The accuracy of an intent classification may be dependent on the accuracy and depth of a domain. Too granular intents may be less generalizable. Entity extraction may use variants of recurrent neural networks (RNNs) to construct RNNs for fixed training data or to extract entities starting from no data. Several HITL approaches may be implemented to overcome the time it may take for attorneys to fix false positives and false negatives while extracting and classifying domains, entities, or intents.

In one implementation, Legal File Generation 100 may integrate a semantic similarity algorithm to generate correct clauses based on intents and context present and may populate fields in a template based on entities present, for example.

Legal File Generation 100 may utilize real-time NLG evaluation and correction. Legal File Generation 100 may enable an assistant to switch document sets being generated when a new domain is being discussed. For example, attorneys may review a document during a call with the client and replay the existing communications for corrected domains and guide the flow of the communications based on intermediate feedback.

At Knowledge Graph Integrated 140, the intents and entities, in addition to context and objectives, may be converted into commands to manipulate a semantic knowledge graph and draft legal documents from the updated knowledge. At Legal Research Engine Integrated 150, data may be received and compared data from external sources, for example, federal and state case law, federal statutes, state statutes, or regulations. At Natural Language Generator Integrated 160, Legal File Generation 100 may match key intents and entities in the communications with the intents and entities in relevant legal documents or templates, for example.

At Document Generator Initiated 170, Legal File Generation 100 may populate fields in a legal template or begin drafting content for a legal document based on the domain, entities, or intents matched. At Document Edited, Updated 180, the user, for example, the attorney, may make updates or revisions to the legal document that will ultimately comprise a work product. At Learning from Client's Existing Data Imported 190, data from a user, such as a client, along with a document draft, updates, or revisions, may feed into Learning Engine Integrated 185, which may continuously learn new data. At Legal Document Created 195, a final work product or an updated draft may be created.

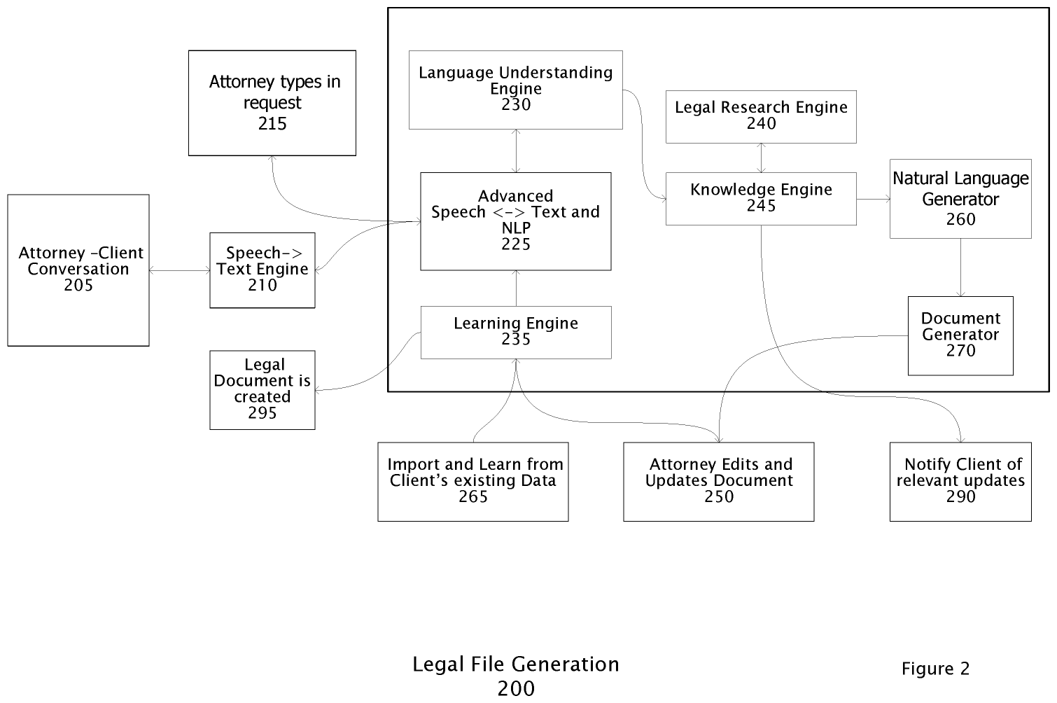

FIG. 2 is a block diagram showing components that may be used in Legal File Generation 200, according to one implementation. Attorney-Client Conversation 205 may be captured and fed into Speech-to-Text Engine 210. Speech-to-Text Engine 210 or Attorney Types in Request 215 may provide input to Advanced Speech-to-Text and Natural Language Processing 225, which may convert input that was spoken or typed into tokens. Language Understanding Engine 230 may work in conjunction with Advanced Speech-to-Text and Natural Language Processing 225 to prepare tokens for Knowledge Engine 245. Language Understanding Engine 230 may use a Deep Siamese network on top of BERT and universal sentence encoders, which may match intents and entities in Legal Research Engine 240 to the tokens from Advanced Speech-to-Text and Natural Language Processing 225. Knowledge Engine 245 may then provide input to Natural Language Generator 260, which, in turn, may provide Document Generator 270 with information to generate a desired document. Information may be user-provided, obtained from inquiries, researched, aggregated, or obtained from databases associated with Legal Research Engine 240. Knowledge Engine 245 may also Notify Client of Relevant Updates 290 if, for example, it finds policy or legal issues based on the intent of the document being created. At Attorney Edits and Updates Documents 250, an attorney may make decisions about clauses to include or exclude in the generated document, which may feed changes back to Learning Engine 235 to improve Legal File Generation 200 over time. Learning Engine 235 may also learn from Importing and Learning from Client's Existing Data 265. Learning Engine 235 may support multi-stage, multi-level learning, and may determine the appropriate level of learning and update that level. Learning Engine 235 may then Create Legal Document 295. Algorithms may intelligently figure out an appropriate level of learning and update that level accordingly. These may include individual user level, division level, organization level, or industry level.

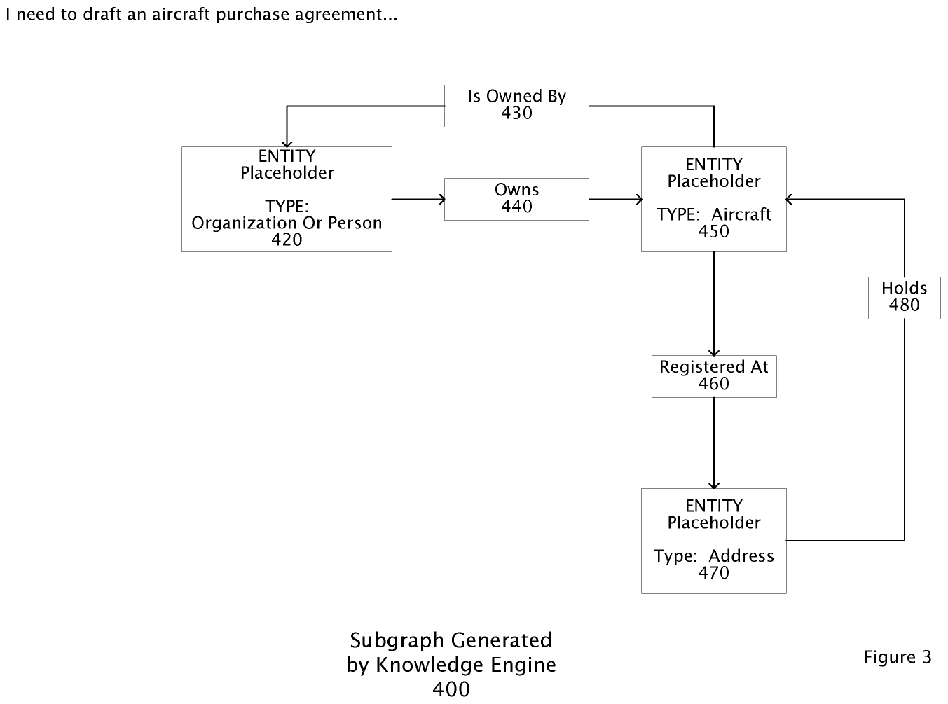

FIG. 3 is a block diagram with components that may be used in Legal File Generation 300, according to one implementation. In this example, a user may comprise an Attorney 305, an In-House Counsel 310, or a Client 315. The user may utilize a front-end application programming interface (API), such as API 320, from a device to access the Legal File Generation 300 platform. Legal File Generation 300 may integrate a speech-to-text conversion API 320 to receive audio inputs from communications between users and convert the audio inputs into text in real-time. API 320 may identify speakers, contents, duration, time, or other attributes and send that information to the Legal File Generation 300 platform.

Legal File Generation 300 may tokenize the text, enter the tokenized text into a token stream, and compare the tokenized text in the token stream to data stored in a language understanding engine database.

In one implementation, Natural Language Processor 330 may send or receive data with Intent Processor 345 to understand and interpret the text from the communications. Legal File Generation 300 may extract and classify one or more domains, for example, an area of law, from the tokenized text in the token stream. Legal File Generation 300 may also extract from the tokenized text one or more user intents, for example, a desire to draft a will or a contact. Legal File Generation 300 may also extract from the tokenized text one or more entities relevant to the communications or the document that will ultimately comprise the attorney work product. An entity may comprise a testator, an executor, or witnesses to a will, or an entity may comprise parties to a contract, for example. Legal File Generation 300 may classify a domain based on context of the communications to limit the natural language understanding to intents and entities in the domain.

Recordings Database 340 may store audio inputs or portions of the token stream for future processing or improvement of the Legal File Generation 300 platform. In one implementation, Legal File Generation 300 may integrate a Knowledge Engine 325, which may manage a Semantic Knowledge Graph Database 360. Legal File Generation 300 may convert the extracted domains, entities, or intents into commands for manipulating the Semantic Knowledge Graph Database 360. Knowledge Engine 325 may also manage other databases, for example, an Audit Database 350, or a Schedule Database 355.

Legal File Generation 300 may match the extracted domains, entities, or intents with fields in a legal template or another document and integrate a document generator to produce Draft 335 from updated knowledge. A user may revise Draft 335, which may ultimately comprise attorney work product. Data from Draft 335 may feed into a learning engine, which may continuously learn new data, and Draft 335 may send data to Artifacts Database 365 to improve future drafts.

Legal File Generation 200 may integrate Legal Research Engine 370 to receive or compare data from external sources, for example, Federal and State Case Law 375, Federal Statutes 380, State Statutes 385, or Regulations 390.

Domains that are too broad may lead to high error rates in intents and entities, and domains that are too granular may lead to a decrease in generalizability. As a solution, a user may correct a classified domain when false positives exist, or select a domain when the classifier misses it, for example, when there are false negatives, while actively engaging in the communications. Legal File Generation 300 may integrate attention networks to optimize the unsupervised detection or extraction of domain keywords in voice communications between users.

Legal File Generation 300 may enable domains, entities, or intents to switch based on a current domain. Accuracy of an intent classification may depend on an accuracy and depth of an extracted domain, and intents that are too granular may be less generalizable. Legal File Generation 300 may use variants of RNNs and transformer networks for entity extraction. Legal File Generation 300 may construct RNNs for fixed training data, or it may extract entities starting from no data. In addition to using text data, Legal File Generation 300 may utilize multi-modal input. For example, it may combine both audio and text data and build a joint network operable to allow features, such as a client's sentiment, to increase an accuracy of intent detection.

Legal File Generation 300 may integrate a plurality of HITL approaches to expedite tasks of fixing false positives and false negatives during extraction or classification of domains, entities, or intents. Legal File Generation 300 may generate correct clauses based on intents present as per a semantic similarity algorithm and populate fields in a template based on entities present. Legal File Generation 300 may integrate real-time NLG evaluation and correction to further expedite correction of generated language.

Legal File Generation 300 may enable switching of the document sets being generated when a new domain is being discussed. As most AI applications on the market focus on one domain, Legal File Generation 300 may integrate an assistant operable to switch domains. A user, such as an attorney, may be enabled to review a document during communications with the client and may replay the existing communication for corrected domains and guide the flow of the communication based on intermediate feedback.

In one implementation, all data in the Legal File Generation 300 platform may be represented as a graph. For example, entities such as people, organizations, or assets may be connected by relationships. For example, a person may work for an organization, or “Gulfstream GIV” may comprise an aircraft. The following section details operations occurring in a knowledge graph managed by Knowledge Engine 325 for an example scenario of purchasing an aircraft. An example communication may comprise the following conversation:

“I need to draft an aircraft purchase agreement of a Gulfstream GV by Daebag Aircraft Leasing. I think they're in the Cayman Islands.”

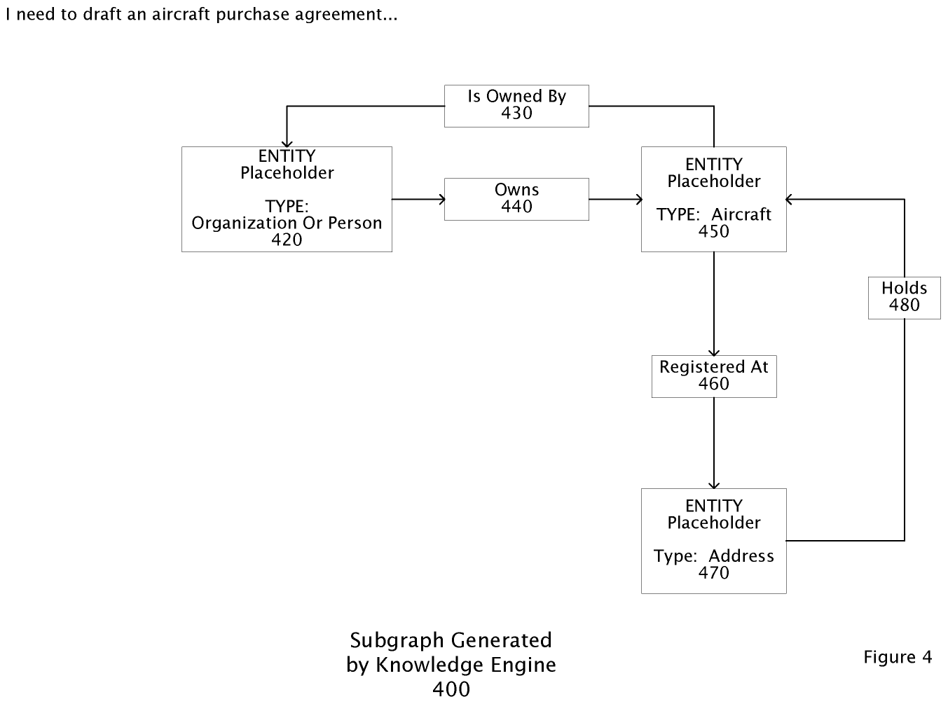

A first step may comprise identification of an action a user wants to take. For example, Legal File Generation 200 may determine that an attorney needs to draft an aircraft purchase agreement from the phrase “I need to draft an aircraft purchase agreement.” The knowledge engine may create a template subgraph, as shown in FIG. 4, for example, which includes placeholder entities that may ultimately hold final values.

Legal File Generation 300 may display or voice-in prompts to gather additional data or correct existing information and allow the users to simultaneously review a draft that is created as they engage in the communications. Legal File Generation 300 may implement custom speech-to-text models for a particular user, for example, an attorney or a client, by integrating a custom speech service. Legal File Generation 300 may integrate a speech-to-text API that includes additional features, for example, a conversation transcription service that creates user profiles before a meeting between users for improved accuracy or that performs real-time speech-to-text conversion.

FIG. 4 illustrates Subgraph Generated by Knowledge Engine 400. Entity 420 may be replaced with one or more participating entities for a contract by Knowledge Engine 245, while Entity Placeholder 450 may be replaced with a subject of the contract, for example. As components analyze the communications from the attorney and product entities, the knowledge engine may use those entities to populate fields in a template subgraph. Replacement of placeholder entities may naturally integrate the subgraph into the rest of the semantic knowledge graph.

For this example, the knowledge engine may identify an aircraft type as a Gulfstream GV from the phrase “for a Gulfstream G5” and may pull in an existing subgraph for it. Since Gulfstream G5 is a product that must be individually tracked with a serial number (as opposed to a commodity type product, like corn, that is not individually tracked), the Gulfstream G5 may be identified as an Aircraft Type. Legal File Generation may create a new node called an Aircraft with an unknown serial number, and that new node may be linked back to the aircraft type. This new node may take the place of the “aircraft” placeholder entity in the template.

As the Legal File Generation platform continues to parse the rest of the attorney's statement, it may produce the “Daebag Aircraft Leasing” corporation entity from the phrase “by Daebag Leasing . . . I think they're in the Cayman Islands.” The knowledge may find this entity in the semantic knowledge graph, and it may take the place of the owner Entity 420, who Owns 440 The Gulfstream GV, which is Owned By 430 Entity 420.

For an Entity 450 that is an Aircraft, a Registration 460 may be required at an Entity 470 that is an address, which Holds 480 the registration for Entity 450.

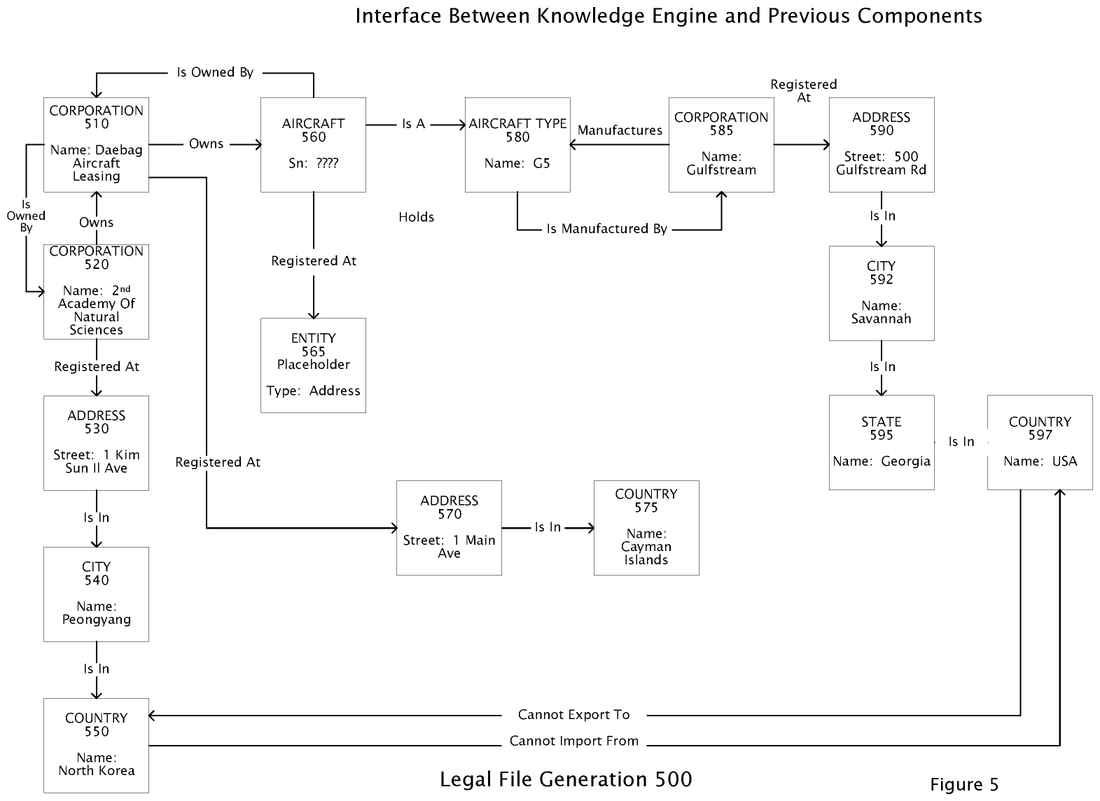

FIG. 5 is an example of an interface between a knowledge engine and subgraph components, which may be supported by a Legal File Generation method, according to one implementation. Another step may comprise an identification of constraint violations. The semantic knowledge graph may include Office of Foreign Assets Control (OFAC) data, on which entities in the world are subject to export controls. In this example, the knowledge graph may have determined an existing connection between Corporation 510 “Daebag Aircraft Leasing” at Address 570 in Country 575, the Cayman Islands, and Corporation 520 “2nd Academy of Natural Sciences,” at Address 530 in City 540, Pyeongyang, in Country 550, North Korea. The former may be a holding company owned by the latter, represented by the “owns” and “is owned by” relationship between those two entities. Corporation 510 may own Aircraft 560, of Aircraft Type 580, which may be registered at Entity 565. Furthermore, OFAC rules on export controls may also already be present in the graph; entities registered in the United States cannot export to entities registered in North Korea, and entities registered in North Korea cannot import products from entities registered in the United States. The G5 may be a product manufactured by Corporation 585, Gulfstream, registered at Address 590, City 592, State 595, and Country 597, a company registered in the United States.

While the Legal File Generation engine may not prevent this connection from taking place, it may identify this as a constraint violation to the attorney and allow that attorney to flag the transaction as against OFAC rules.

Legal File Generation may integrate a text generation approach that is extractive, and it may use generative 13 and abstractive 14 approaches.

Legal File Generation may integrate speech generation that may utilize Amazon Web Services (AWS) Polly or Microsoft Text to Speech Services that may allow the Legal File Generation platform to interact with the users, not just with text, but also with audio. It may implement multiple voices, eight or more, for example, for its AI to provide more variety.

Legal File Generation may integrate a user interface (UI) for collecting data from users to improve machine learning models.

The Legal File Generation platform may a containerized microservice architecture. For example, the architecture may integrate AWS, Azure, or Google Compute infrastructure and services for text to speech and data storage.

Legal File Generation 500 platform may run in a managed Kubernetes cluster across multiple availability zones for fault tolerance in one implementation. It may run in one or more data centers to support demand.

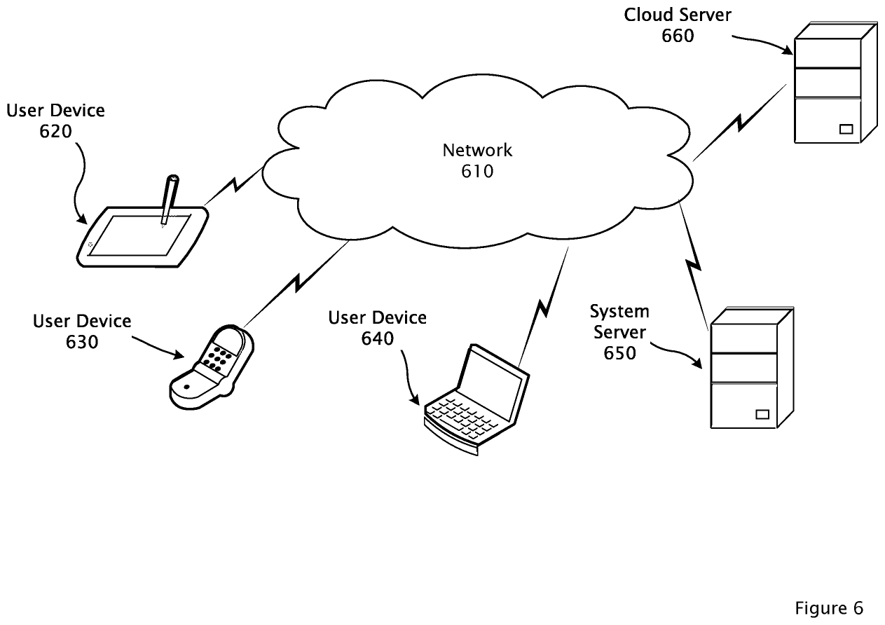

FIG. 6 is a block diagram illustrating an example of a system capable of supporting a legal file generation method, according to one implementation. Network 610 may include WI-FI wireless networking, Wi-Fi 6, cellular data access methods, such as 3G, 4GLTE, 5G, BLUETOOTH low-power wireless connectivity technology, Near Field Communications (NFC), Ethernet connectivity, fiber optic connections, the internet, local area networks, wide area networks, or any combination of these or other means of providing data transfer capabilities.

User Device 620, 630, or 640 may have network capabilities to communicate with System Server 650 or Cloud Server 660. System Server 650 and Cloud Server 660 may each include one or more computers and may serve a number of roles. System Server 650 or Cloud Server 660 may be conventionally constructed or may be of a special purpose design for processing data obtained from Legal File Generation. One skilled in the art will recognize that System Server 650 or Cloud Server 660 may be of many different designs and may have different capabilities.

One having skill in the art will recognize that various configurations for User Device 620, 630, or 640 and System Server 650 or Cloud Server 660 may be used to implement Legal File Generation.

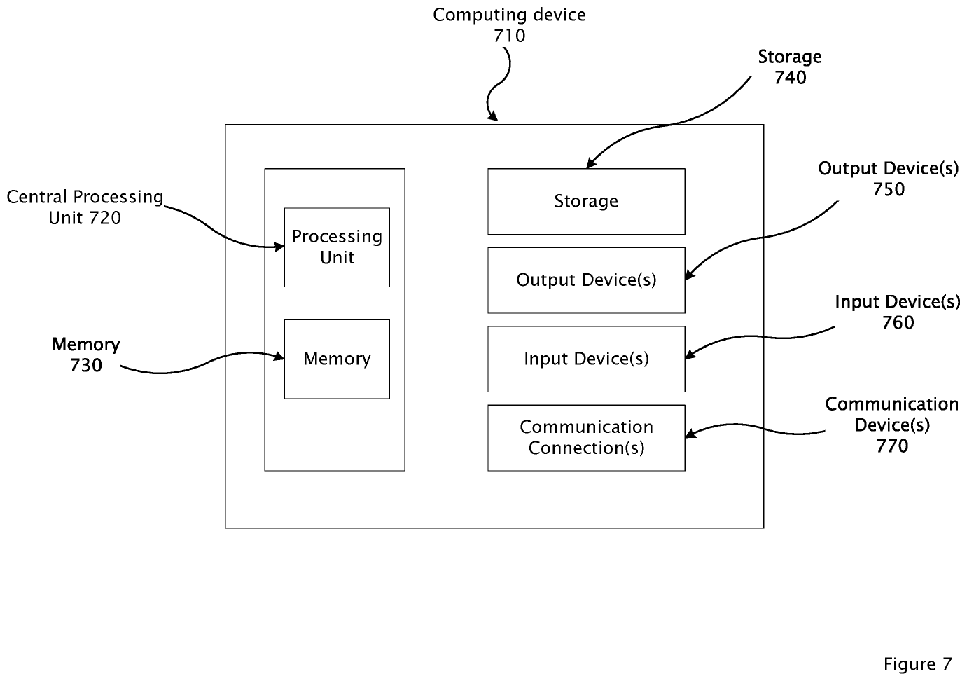

FIG. 7 is a component diagram of a computing device that may support a Legal File Generation method, according to one implementation.

Computing Device 710 may be utilized to implement one or more computing devices, computer processes, or software modules described herein, including, for example, but not limited to a mobile device. In one example, Computing Device 710 can be used to process calculations, execute instructions, and receive and transmit digital signals. In another example, Computing Device 710 can be utilized to process calculations, execute instructions, receive and transmit digital signals, receive and transmit search queries and hypertext, and compile computer code suitable for a mobile device. Computing Device 710 can be any general or special purpose computer now known or to become known capable of performing the steps or performing the functions described herein, either in software, hardware, firmware, or a combination thereof.

In its most basic configuration, Computing Device 710 typically includes at least one Central Processing Unit (CPU) 720 and Memory 730. Depending on the exact configuration and type of Computing Device 710, Memory 730 may be volatile (such as RAM), non-volatile (such as ROM, flash memory, etc.), or some combination of the two. Additionally, Computing Device 710 may also have additional features/functionality. For example, Computing Device 710 may include multiple CPUs. The described methods may be executed in any manner by any processing unit in Computing Device 710. For example, the described process may be executed by both multiple CPUs in parallel.

Computing Device 710 may also include additional storage (removable or non-removable), including magnetic or optical disks or tape. Such additional storage is illustrated by Storage 740. Computer-readable storage media includes volatile and non-volatile, removable, and non-removable media implemented in any method or technology for storage of information such as computer-readable instructions, data structures, program modules, or other data. Memory 730 and Storage 740 are all examples of computer-readable storage media. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage, or other magnetic storage devices, or any other medium which can be used to store the desired information and which can be accessed by Computing Device 710. Any such computer-readable storage media may be part of Computing Device 710. But computer-readable storage media does not include transient signals.

Computing Device 710 may also contain Communications Device(s) 770 that allow the device to communicate with other devices. Communications Device(s) 770 is an example of communication media. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. The term computer-readable media, as used herein, includes both computer-readable storage media and communication media. The described methods may be encoded in any computer-readable media in any form, such as data, computer-executable instructions, and the like.

Computing Device 710 may also have Input Device(s) 760, such as a keyboard, mouse, pen, voice input device, touch input device, etc. Output Device(s) 750 such as a display, speakers, printer, etc., may also be included. All these devices are well-known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download software packages as needed or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like. While the detailed description above has been expressed in terms of specific examples, those skilled in the art will appreciate that many other configurations could be used. Accordingly, it will be appreciated that various equivalent modifications of the above-described implementations may be made without departing from the spirit and scope of the invention.

Additionally, the illustrated operations in the description show certain events occurring in a certain order. In alternative implementations, certain operations may be performed in a different order, modified, or removed. Moreover, steps may be added to the above-described logic and still conform to the described implementations. Further, operations described herein may occur sequentially, or certain operations may be processed in parallel. Yet further operations may be performed by a single processing unit or by distributed processing units.

1. A legal file generation method, comprising the steps of:
receiving an input comprising a first information related to a legal document to be generated;
selecting a second information from a data store or model to augment the first information; and
using the first information and the second information to produce the legal document.

2. The method of claim 1, further comprising receiving additional information from facts, rules, or regulations sourced within a database internal to a legal file generation system.

3. The method of claim 1, further comprising receiving additional information from facts, rules, or regulations sourced within a database external to a legal file generation system.
